(19) United States
(12) Patent Application Publication
(10) Pub. No.: US 2025/0240598 A1
(43) Pub. Date: Jul. 24, 2025

(54) VEHICLE PARAMETER VALUE ARBITRATION

(71) Applicant: Textron Inc., Providence, RI (US)

(72) Inventors: Gregory August Theodosakis, Martinez, GA (US); Russell William King, Evans, GA (US); Jonathan Daniel Bowen, North Augusta, SC (US)

(73) Assignee: Textron Inc., Providence, RI (US)

(21) Appl. No.: 18/419,491

(22) Filed: Jan. 22, 2024

(51) Int. Cl. H04W 4/021; B60L 58/12; B60W 30/02; B60W 50/14

(52) U.S. Cl. CPC H04W 4/021; B60L 58/12; B60W 30/02; B60W 50/14; B60W 2050/146; B60W 2300/405; B60W 2555/20

(57) ABSTRACT

A vehicle system includes at least one processing circuit having at least one processor and at least one memory. The at least one memory stores instructions thereon that, when executed by the at least one processor, cause the at least one processor to: receive a parameter rule associated with a vehicle parameter; receive a persistent value for the vehicle parameter; determine that a user-set value for the vehicle parameter is active; determine that a context-based value for the vehicle parameter is active; and set the vehicle parameter to one of the persistent value, the user-set value, or the context-based value based on the parameter rule.

### BACKGROUND

Off-road machines or vehicles are used in a variety or scenarios for a variety of purposes. For example, all-terrain vehicles (“ATVs”) and utility task vehicles (“UTVs”) may be used for off-road exploration or performing a variety of tasks requiring off-road capabilities. Other lightweight or recreational machines (e.g., golf carts, lawnmowers, other chore products) can be used in a variety of other contexts to perform specific chores or to make travel between different locations more convenient. In some instances, these types of vehicles communicate with various devices over vehicle data networks.

### SUMMARY

One embodiment relates to a vehicle system. The vehicle system includes at least one processing circuit having at least one processor and at least one memory. The at least one memory stores instructions thereon that, when executed by the at least one processor, cause the at least one processor to receive a parameter rule associated with a vehicle parameter. The instructions further cause the at least one processor to receive a persistent value for the vehicle parameter. The instructions further cause the at least one processor to determine that a user-set value for the vehicle parameter is active. The instructions further cause the at least one processor to determine that a context-based value for the vehicle parameter is active. The instructions further cause the at least one processor to set the vehicle parameter to one of the persistent value, the user-set value, or the context-based value based on the parameter rule.

Another embodiment relates to a vehicle control system. The vehicle control system includes at least one processing circuit having at least one processor and at least one memory. The at least one memory stores instructions thereon that, when executed by the at least one processor, cause the at least one processor to receive a parameter rule associated with a vehicle parameter. The instructions further cause the at least one processor to receive a persistent value for the vehicle parameter. The instructions further cause the at least one processor to determine that one or more of a user-set value for the vehicle parameter is active or a context-based value for the vehicle parameter is active. The instructions further cause the at least one processor to set the vehicle parameter to one of the persistent value, the user-set value, or the context-based value based on the parameter rule and the determination that the one or more of the user-set value or the context-based value is active.

Still another embodiment relates to a method. The method includes receiving, by at least one processing circuit, a persistent value for a vehicle parameter. The method further includes determining, by the at least one processing circuit, that a user-set value for the vehicle parameter is active based on user-set parameter command information received from a user interface device. The method further includes determining, by the at least one processing circuit, that a context-based value for the vehicle parameter is active based on context-based parameter command information received from a context analysis device or system. The method further includes setting, by the at least one processing circuit, the vehicle parameter to one of the persistent value, the user-set value, or the context-based value based on a parameter rule.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a flowchart of a method for arbitrating conflicting parameter values for a vehicle parameter, according to an exemplary embodiment.

FIG. 5 is a table showing a vehicle parameter value arbitration scenario, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, systems and methods are provided for a vehicle control system (e.g., a local vehicle control system on a vehicle or a remote vehicle control system configured to control a vehicle) that effectively arbitrates between conflicting parameter value commands from multiple connected devices relating to any of a variety of vehicle parameters (e.g., maximum vehicle speed, maximum acceleration rate, maximum drive power level, maximum battery charge threshold, a minimum battery health state, a vehicle stability control level, a vehicle anti-skid control level, etc.). The systems and methods allow for the vehicle control system to set the vehicle parameter at an appropriate value selected from a group of active and conflicting parameter value commands based on one or more predetermined rules associated with the corresponding vehicle parameter.

Traditionally, when a vehicle control system has set a parameter value (e.g., based on a user or operator input) and the vehicle control system receives a new conflicting command from another device, the vehicle control system simply updates and overwrites the initially set parameter value. As such, if a user or operator wants to return the parameter value to the initial parameter, the user or operator would need to manually reset the parameter value. Further, when traditional vehicle control systems receive conflicting parameter commands from different devices simultaneously, undesired results are generally possible. For example, without special logic to handle this interaction, if two devices are simultaneously trying to alter a given vehicle parameter (e.g., the vehicle's top speed), an undesirable situation could occur where the vehicle control system rapidly fluctuates the vehicle parameter between the two conflicting parameter commands instead of selecting an appropriate value between the two.

Accordingly, the systems and methods described herein allow a vehicle control system to effectively receive conflicting parameter commands relating to a vehicle parameter from different devices and select an appropriate parameter value. As such, the systems and methods described herein allow for any number of devices to have influence over a given vehicle parameter while intelligently managing conflicting commands such that “race conditions” or ambiguous/undesired states are never entered or prevented. Further, by allowing for the vehicle control system to continuously receive, temporarily store, and selectively consider or disregard each of the received conflicting parameter commands, the systems and methods described herein avoid permanently or persistently altering a user's custom settings. For example, in the case of a device failure that would otherwise require the user to reset a particular vehicle parameter manually, the failed device's parameter command would no longer be active, and would thus be disregarded by the vehicle control system. Accordingly, the vehicle control system would automatically revert to the still-active user-set parameter value.

### Overall Vehicle

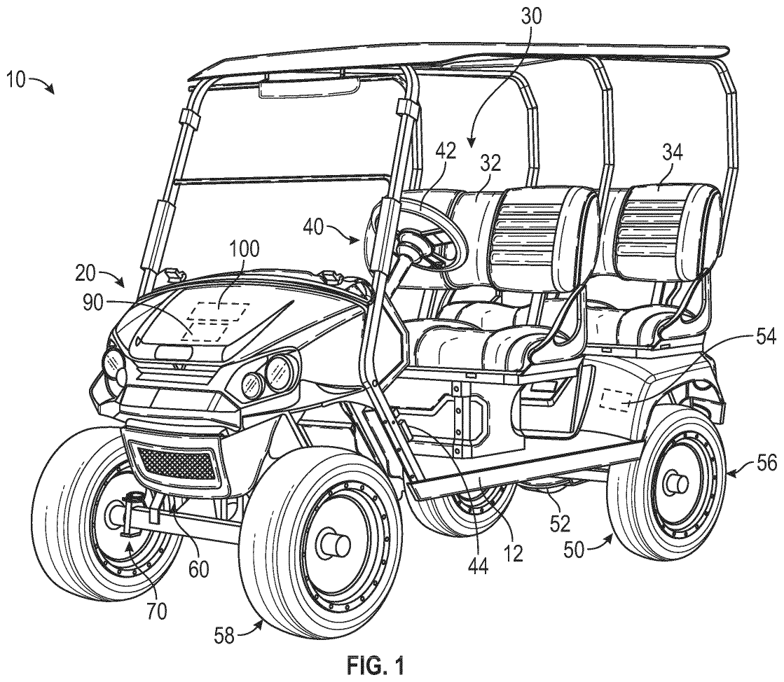

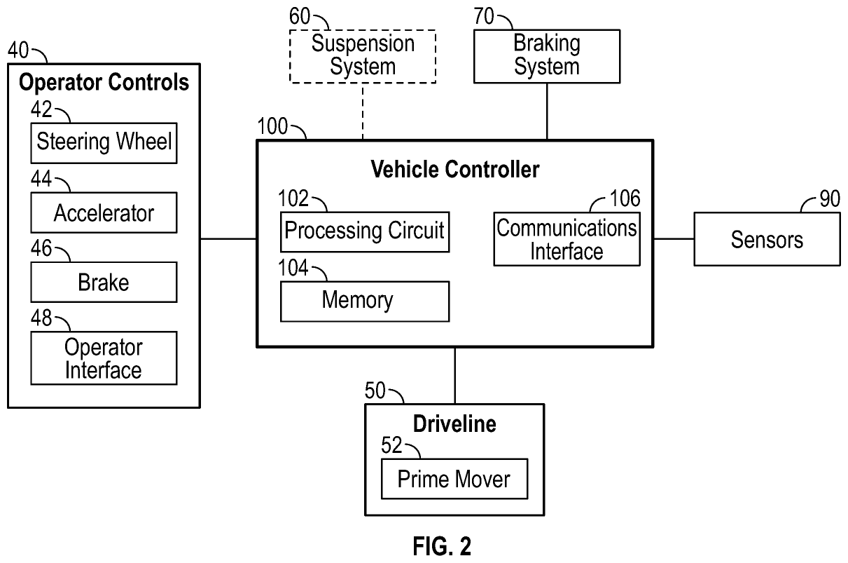

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a vehicle control system, shown as vehicle controller 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown as steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., a traction motor) and the energy storage 54 is a battery system including an on-board charger or chargeable via a separate charger. In some embodiments, the driveline 50 is a fuel cell electric driveline whereby the prime mover 52 is an electric motor (e.g., a traction motor) and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the braking functionality of the braking system 70 is supplemented or replaced with motor braking enabled by an electric motor (e.g., prime mover 52) that is also configured to propel the vehicle 10.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102.

In some embodiments, the vehicle controller 100 may represent a collection of processing devices. In such cases, the processing circuit 102 represents the collective processors of the devices, and the memory 104 represents the collective storage devices of the devices. For example, in some embodiments, the vehicle controller 100 may comprise or otherwise represent a driveline controller (e.g., a motor controller), an energy storage management system (e.g., a battery management system), and/or any other control system of the vehicle 10.

In one embodiment, the vehicle controller 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle controller 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communications interface 106).

### Site Monitoring and Control System

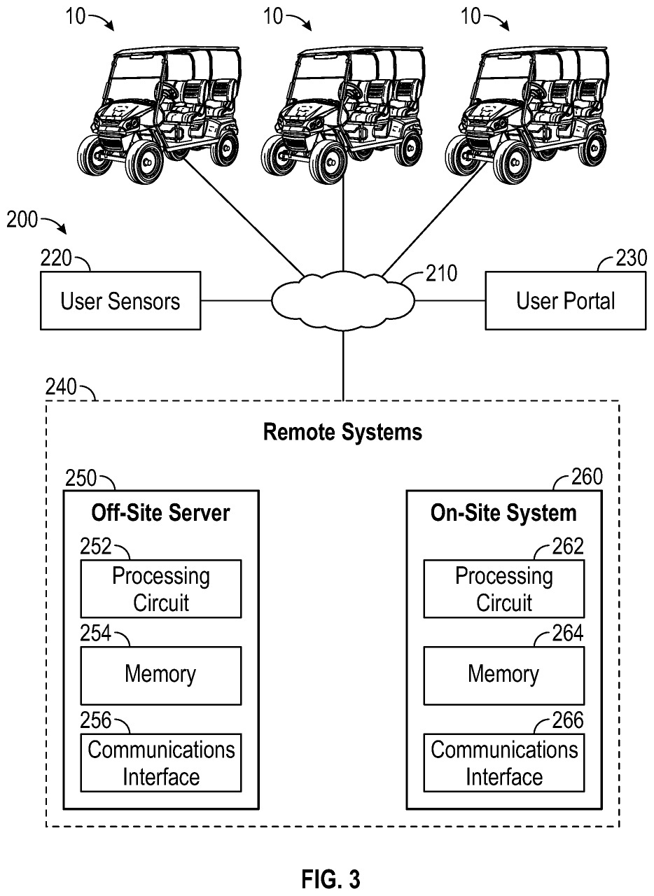

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may be or may be accessed via a computer, laptop, smartphone, tablet, or the like.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266. In some embodiments, the off-site server 250 is a cloud-based server.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Vehicle Parameter Value Arbitration

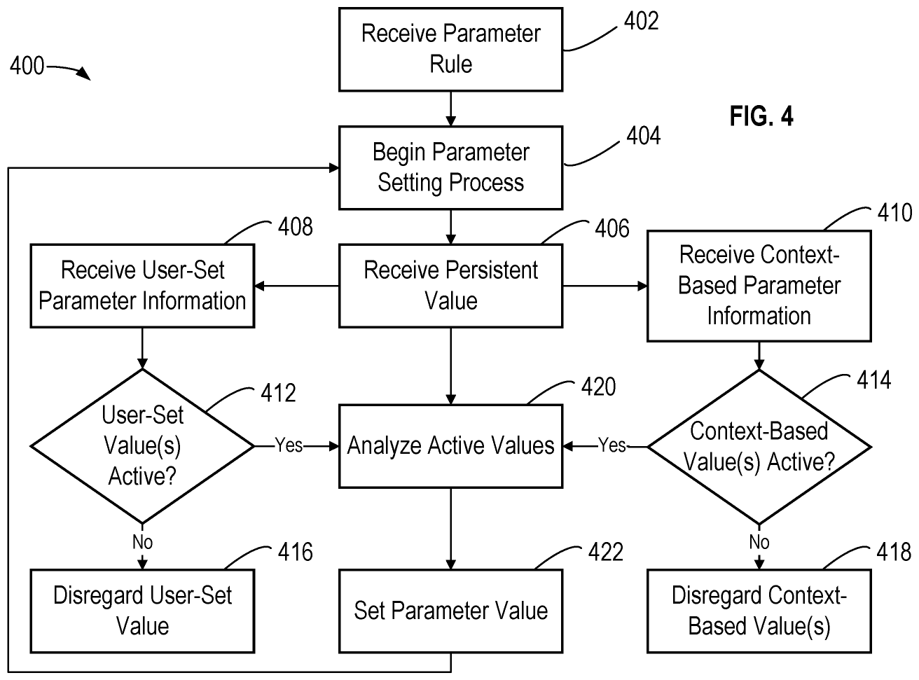

Referring now to FIG. 4, a method for arbitrating between conflicting vehicle parameter value commands from multiple devices is provided below. It should be appreciated that the following description is provided as an example and is in no way meant to be limiting. Furthermore, it should be appreciated that, in some embodiments, various steps may be added, omitted, and/or rearranged within the method 400 without departing from the scope of the present disclosure. In some embodiments, the method 400 is performed by the vehicle controller 100. In other embodiments, the method 400 is performed by one of the remote systems 240 (e.g., the off-site server 250 or the on-site system 260) or another cloud-based server configured to provide control commands to the vehicle 10. In some embodiments, the method 400 is performed by a combination of the vehicle controller 100 and the remote systems 240.

As a general overview, the method 400 allows for the vehicle controller 100 and/or the remote systems 240 to receive parameter value commands from multiple connected devices relating to any of a variety of vehicle parameters and to effectively arbitrate between conflicting commands to set the vehicle parameter at an appropriate value based on one or more predetermined rules associated with the corresponding vehicle parameter. It should be appreciated that, while the method 400 is described in the context of a single parameter rule for arbitrating between conflicting commands for setting a single vehicle parameter, the vehicle controller 100 and/or the remote systems 240 can receive and utilize any number of parameter rules for arbitrating between conflicting commands for setting any number of vehicle parameters in a similar manner.

The method 400 begins with receiving a parameter rule associated with a vehicle parameter, at step 402. In some embodiments, a user (e.g., a technician, a vehicle owner, a manufacturer, etc.) provides the parameter rule to the vehicle controller 100 and/or one of the remote systems 240 via a user interface (e.g., the operator interface 48). The parameter rule provides an indication to the vehicle controller 100 and/or the remote system 240 regarding how to resolve conflicting parameter value commands from multiples devices for setting the vehicle parameter. In some embodiments, the vehicle parameter is one of a maximum speed of the vehicle 10, a maximum acceleration rate of the vehicle 10, a stability control level of the vehicle 10 (e.g., a preset response level to potential roll conditions configured to eliminate or reduce roll-over events and/or the sensation of the operator being pulled to one side of the vehicle 10 while the vehicle 10 is turning), a maximum battery charge threshold of the battery system (e.g., the energy storage 54), a minimum battery health state of the battery system (e.g., the energy storage 54), an anti-skid control level (e.g., a preset sensitivity level for responding to detected skid events), or a maximum drive power level of the vehicle 10. In some embodiments, the vehicle parameter can be any other vehicle parameter that is adjustable in response to received parameter value commands.

In some embodiments, the parameter rule can specify that a lowest parameter value must be selected. For example, this type of parameter rule may be utilized for vehicle parameters such as maximum speed, maximum acceleration rate, maximum battery charge, maximum power level, or any other type or vehicle parameter where a lowest parameter value selection would be desirable (e.g., for the vehicle 10, the operator, and/or third parties). In some embodiments, the parameter rule can specify that a highest parameter value must be selected. For example, this type of parameter rule may be utilized for vehicle parameters such as stability control level, a minimum battery health state, anti-skid control level, or any other type of vehicle parameter where a highest parameter value selection would be desirable (e.g., for the vehicle 10, the operator, and/or third parties).

In some embodiments, the parameter rule can specify a device hierarchy to be used when selecting a parameter value to utilize. For example, the parameter rule can specify that a first parameter value command from a first device takes priority over a second parameter value command from a second device, such that, in the case of conflicting parameter value commands, the vehicle controller 100 and/or the remote system 240 must select the first parameter value. In some instances, a first device hierarchy for a first vehicle parameter can be different than a second device hierarchy for a second vehicle parameter.

In some embodiments, the parameter rule can be multifaceted. For example, in some embodiments, the parameter rule can specify that a lowest parameter value must be selected unless an override parameter value is received, in which case the override parameter takes priority and must be selected. Using maximum speed as an example, the parameter rule can specify that, notwithstanding a lower maximum speed value being active, in the case that a higher speed value associated with an inclement weather notification has been received, the vehicle speed must be set to the higher speed value (e.g., to allow for the operator to seek shelter more quickly). In some instances, the parameter rule can be altered or updated in real-time or near real-time by an operator having an override authorization upon the operator entering a credential (e.g., a password, a PIN, a biometric, scanning a badge, etc.) associated with a user identity or operator identity having the override authorization.

For example, as discussed below, in some instances, the parameter rule can deactivate or otherwise disable the vehicle 10 if a minimum speed associated with a geofenced area is higher than a maximum speed allowed by the parameter rule or if the vehicle 10 has entered a geofenced area within which the vehicle 10 is not allowed to drive. In these instances, an operator having an override authorization (e.g., a superintendent, a maintenance worker) could enter a credential to enable the operator to override the parameter rule to allow for operation of the vehicle 10 (e.g., to move the vehicle 10 out of the geofenced area).

Once the parameter rule has been received, at step 402, the parameter setting process can begin, at step 404. In some embodiments, the vehicle controller 100 and/or the remote systems 240 receives a persistent value for the vehicle parameter (e.g., via the communications network 210, via a technician tool, at the time of manufacturing, etc.), at step 406. The persistent value is a default value for the vehicle parameter to be utilized if no other values are active. As such, the persistent value is always active, such that it will always be considered when setting the parameter value, as will be discussed below.

In some embodiments, the persistent value is set during assembly of the vehicle 10 (e.g., as part of an initial programming of the vehicle controller 100). In some other embodiments, the persistent value is set or modified by an operator or user of the vehicle 10. For example, the operator or user of the vehicle 10 may be able to utilize a diagnostic tool, the operator interface 48, or the user portal 230 to modify the persistent value. In some instances, modifying the persistent value may require entry of a passcode (e.g., a personal identification number), password, a biometric, or some other form of authentication before the operator or user is authorized to modify the persistent value.

In some embodiments, the vehicle controller 100 and/or the remote systems 240 additionally receive user-set parameter command information associated with the vehicle parameter (e.g., via the communications network 210), at step 408. The user-set parameter command information includes a user-set activity status and a user-set value for the vehicle parameter. The user-set activity status is an indication of whether the user-set value is currently active and should thus be considered when setting the vehicle parameter. In some embodiments, the user-set value can be set and selectively activated and deactivated by a user or operator via the operator interface 48 or the user portal 230.

For example, in some instances, a primary user (e.g., an owner) may wish to allow a secondary user (e.g., a guest) to use the vehicle 10, but may wish to limit the maximum speed that the vehicle 10 can travel while secondary user is using the vehicle 10. Accordingly, the primary user can set and selectively activate a user-set value for the maximum vehicle speed when the secondary user is using the vehicle 10. Because the user-set value is activated, it will be considered by the vehicle controller 100 and/or the remote systems 240 when setting the maximum vehicle speed. Continuing with this example, when the primary user again wishes to operate the vehicle, the primary user can deactivate the lower user-set value by entering a credential (e.g., a password, a PIN, a biometric, etc.) associated with the user-set value via the operator interface 48 or the user portal 230.

In some embodiments, the user-set parameter command information may include multiple user-set activity statutes and multiple corresponding user-set values for the vehicle parameter. For example, continuing with the example above, the primary user may wish to set different maximum speeds for different secondary users (e.g., different guests, etc.). Accordingly, the primary user can set multiple user-set values for the maximum vehicle speed, and each secondary user (as well as the primary user) can activate their own maximum vehicle speed and deactivate the other maximum vehicle speeds using a corresponding credential via the operator interface 48 or the user portal 230. In some instances, the second users may be allowed to request permission (e.g., via the operator interface 48 or the user portal 230) from the primary user to increase or temporarily increase their respective maximum vehicle speed, and the primary user can allow or deny the request by entering a corresponding credential (e.g., via the operator interface 48 or the user portal 230).

In some embodiments, the vehicle controller 100 and/or the remote systems 240 additionally receive context-based parameter command information associated with the vehicle parameter (e.g., via the communications network 210), at step 410. The context-based parameter command information similarly includes a context-based activity status and a context-based value for the vehicle parameter. The context-based activity status is similarly an indication of whether the context-based value is currently active and should thus be considered when setting the vehicle parameter.

The context-based parameter command information can be received from any context analysis device or system configured to analyze and respond to contextual information pertaining to the vehicle 10. For example, the context analysis devices and systems may include the operator controls 40, the driveline 50, the suspension system 60, the braking system 70, the sensors 90, user sensors 220, the remote systems 240, and/or any other device or system configured to monitor or otherwise determine contextual information pertaining to the vehicle 10 and to command and/or otherwise activate parameter values for consideration.

The context-based value and its associated context-based activity status are effectively predetermined scenarios in which a given vehicle parameter is to be limited or restricted to above or below a given value based on contextual information pertaining to the vehicle 10. These predetermined scenarios and corresponding contextual information can be any of a variety of scenarios and contextual information, such as, for example, the vehicle 10 entering or being located with a geofenced area, the vehicle 10 driving on a slope, the vehicle 10 actively turning, the vehicle 10 experiencing inclement weather, or any other scenario in which an operator or programmer wishes to have the vehicle parameter altered, limited, restricted, or unrestricted.

In some embodiments, the context-based value and one or more rules for when the context-based value will be activated can be set by a user, an operator, and/or a third party (e.g., a golf course manager) via the operator interface 48, the user portal 230, one of the remote systems 240, or a third-party computing system (e.g., a golf course management computing system at a golf course). It should be appreciated that, for any given vehicle parameter, multiple context-based values and associated rules can be set for a number of different predetermined scenarios.

For example, as mentioned above, the vehicle controller 100 and/or the remote systems 240 may be configured to monitor GPS information regarding the vehicle 10. In some embodiments, upon detecting that the vehicle 10 has entered a GPS-defined or geofenced region (e.g., a golf course, a club house area of the golf course, etc.), the remote systems 240 may be configured or otherwise programmed to transmit a GPS- or geofence-based activity status to the vehicle controller 100 (or to update a GPS- or geofence-based activity status locally) indicating that a GPS- or geofence-based speed limit is active. Accordingly, the vehicle controller 100 and/or the remote systems 240 will consider the GPS- or geofence-based speed limit when setting the maximum speed value, as discussed below. In some instances, the geofence-based speed limit may be set to zero (e.g., effectively disabling the vehicle 10). For example, if there are areas within a region of interest (e.g., a golf course) where the vehicle 10 is not allowed to drive in, the areas can be associated with a geofence that sets the maximum speed to zero to effectively disable the vehicle 10. In other instances, the geofence-based speed limit may be set to other values.

It should be appreciated that various other GPS- or geofence-based parameter rules can be set up for a variety of the vehicle parameters described herein, as desired for a given application. Further, in some embodiments, multiple geofenced areas and/or other predefined locational regions can have multiple different associated context-based values for vehicle parameters. For example, in some embodiments, the remote systems 240 (or other third-party systems configured to communicate with and communicate vehicle parameter commands with the vehicle 10) can set multiple different speed limitations throughout a golf course (e.g., on a fairway, in the rough, near a green, near a tee box, near the clubhouse, etc.) or throughout another venue generally, as desired for a given application. In some embodiments, GPS- or geofenced-based parameter values associated with a given geofenced area or other predefined locational region can be periodically or regularly updated or modified. For example, a given geofenced area or other predefined locational region may have different maximum speeds depending on a day of the week (e.g., based on a set time, weekly, or event schedule; weekday vs. weekend; holiday vs. non-holiday; during a tournament vs. not during a tournament; etc.).

In some embodiments, the remote systems 240 may be configured to monitor local weather and to provide weather-based parameter information including a weather-based parameter value and a weather-based activity status to the vehicle controller 100 (or to update a weather-based activity status locally). The weather-based activity status can be set to active by the remote systems 240 upon detection or receipt of a notification indicative of the vehicle 10 experiencing inclement weather or inclement weather approaching. As will be described further below, in some instances, the weather-based parameter value may act as an override value and be selected over any other potential parameter value (e.g., to allow for a maximum speed of the vehicle 10 to be increased during inclement weather to allow the operator to more quickly travel to shelter).

Once the user-set parameter command information has been received, at step 408, and the context-based parameter command information has been received, at step 410, the vehicle controller 100 and/or the remote systems 240 then determine whether the user-set value is active, at step 412, and whether the context-based value is active, at step 414. If the user-set value is not active, the vehicle controller 100 and/or the remote systems 240 are configured to disregard the user-set value, at step 416. Similarly, if the context-based value is not active, the vehicle controller 100 and/or the remote systems 240 are configured to disregard the context-based value, at step 418. Alternatively, as shown FIG. 4, if the user-set value and/or the context-based value are active, the vehicle controller 100 and/or the remote systems 240 are configured to include the user-set value and/or the context-based value in the analysis performed at step 420.

Once the active parameter values have been determined, the vehicle controller 100 and/or the remote systems 240 then analyze the active values, at step 420, and set the parameter value, at step 422. For example, the vehicle controller 100 and/or the remote systems 240 analyze the active values to identify the correct value at which to set the parameter value based on the parameter rule received at step 402.

Once the parameter value has been set, at step 422, the method 400 returns to the beginning of the parameter setting process, at step 404. That is, in some embodiments, steps 404-422 are run in a continuous or substantially continuous loop by the vehicle controller 100 and/or the remote systems 240. Accordingly, as user-set values and context-based values are activated, they are considered in real-time or near real-time and, if appropriate based on the parameter rule, set as the parameter value for the vehicle parameter. Similarly, if a user-set value or a context-based value is set as the parameter value based on the parameter rule, and that user-set value or context-based value is deactivated, that user-set value or context-based value is disregarded and the parameter value will be adjusted to a new value based on the remaining activated values.

In some embodiments, once the vehicle parameter is set, it is temporarily stored (e.g., in the memory 104) such that, if the vehicle 10 is turned off and back on, the vehicle controller 100 can revert back to the set vehicle parameter from immediately prior to the vehicle 10 being turned off. In other embodiments, if the vehicle 10 is turned off and back on, the vehicle controller 100 immediately runs through the method 400 and, assuming no contextual changes have occurred to the vehicle 10 while it was off, the vehicle controller 100 will set the vehicle parameter to the same value as before the vehicle 10 was turned off due to the same parameter values being active (e.g., the persistent value, the user-set value, and/or the context-based value).

Further, it should be appreciated that, because the parameter setting functionality described herein is run in a loop, the parameter value may only be set temporarily and may be regularly updated. As such, in the case of a device failure associated with a device sending commands (e.g., the user-set parameter command information and/or the context-based command information), the vehicle controller 100 and/or the remote systems 240 can quickly recover and update the parameter value to an appropriate parameter by re-running through steps 404-422. Additionally, because the various values (e.g., the persistent value, the user-set value(s), the context-based value(s)) can be received, stored, and selectively considered or disregarded when setting the actual parameter value for a given vehicle parameter, a user-set value for the given vehicle parameter is not permanently or persistently overwritten when the vehicle parameter is updated due to a context-based value (e.g., received from a remote device) being temporarily set based on the corresponding parameter rule.

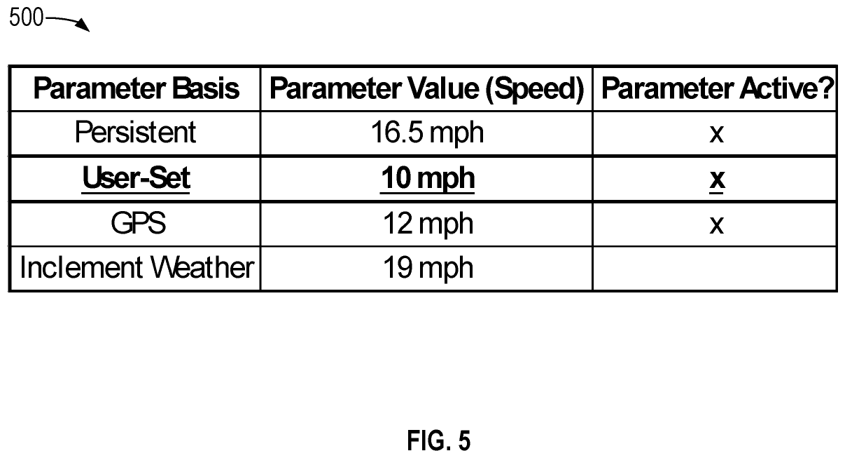

Referring now to FIG. 5, a table 500 showing an example vehicle parameter value arbitration scenario for limiting a maximum vehicle speed is shown. As illustrated, the persistent value for the maximum vehicle speed is set at 16.5 mph, a user-set value for the maximum vehicle speed is set at 10 mph, a GPS-based value for the maximum vehicle speed is set at 12 mph, and a weather-based value for the maximum vehicle speed is set at 19 mph (e.g., a maximum possible speed for the vehicle 10). Further, the persistent value, the user-set value, and the GPS-based value are each active, while the weather-based value is not active.

The parameter rule associated with the vehicle parameter arbitration scenario shown in table 500 indicates that a lowest value is to be selected unless the weather-based value is active. That is, the weather-based value acts as a type of override when active. However, because the weather-based value is not active, in the scenario shown in FIG. 5, the vehicle controller 100 and/or the remote systems 240 are configured to set the maximum vehicle speed at 10 mph, which is the lowest maximum speed value of the three active values. This minimum-based selection process is utilized to select the most conservative/restrictive active speed, which ensures that the vehicle 10 cannot travel beyond the top speed setting of any of the competing devices sending commands (e.g., the user-set parameter command information and/or the context-based command information).

While the arbitration scenario shown in FIG. 5 relates to vehicle speed, it should be appreciated that the arbitration method 400 may allow for a variety of devices to send commands to the vehicle controller 100 and/or the remote systems 240 based on a variety of scenarios and rules. For example, a variety of potential scenarios, rules, and vehicle parameter command types that may be implemented using the systems and methods described above are provided below. The following scenarios are provided as additional examples and are in no way meant to be limiting.

In some embodiments, one or more devices may provide parameter commands associated with a stability control level and/or an anti-skid control level of the vehicle 10. For example, the vehicle controller 100 may be preloaded with multiple preset levels (e.g., level 1, level 2, level 3) of stability control configured to stabilize the vehicle 10 and/or multiple preset levels (e.g., level 1, level 2, level 3) of anti-skid control configured to prevent the vehicle 10 from skidding. Each level of stability control may be associated with different roll angle thresholds, roll rate thresholds, threshold vehicle speeds while the vehicle 10 is turning or driving on an angle or grade, etc. Each level of anti-skid control may be associated with different levels of regeneration, different power limit maps, different grade allowances, different braking parameters, etc.

In some embodiments, one or more user-set or context-based values and corresponding rules may be set at various external devices (e.g., at the operator interface 48, the user portal 230, the remote systems 240, another external device) to send commands to the vehicle controller 100 and/or the remote systems 240 regarding which level of stability control and/or which level of anti-skid control to implement. For example, these rules and commands can be based on one or more operational parameters of the vehicle 10 sensed by sensors 90 (e.g., a vehicle orientation grade angle, a vehicle turning angle, a wheel slip detection, a motor torque, a motor temperature, an ambient temperature near the vehicle, etc.) or determined based on data sensed by the sensors 90 (e.g., an inferred payload detected based on sensed motor torque and/or controller output). Accordingly, in the case of conflicting commands, the vehicle controller 100 and/or the remote systems 240 can select which of the stability control levels and/or which of the anti-skid control levels to implement based on corresponding parameter rules. For example, in some instances, the parameter rules may cause the vehicle controller 100 and/or the remote systems 240 to select the highest level of stability control and/or anti-skid control, such that the selected stability control and/or anti-skid control meets the requirements of each of the commanding devices.

In some embodiments, one or more devices may provide parameter commands associated with a maximum charge threshold for charging the battery system (e.g., the energy storage 54). For example, in some instances, a battery management system of the vehicle 10 (e.g., implemented within the vehicle controller 100, separate from the vehicle controller 100 on the vehicle 10, and/or within one of the remote systems 240) can send a context-based command to the vehicle controller 100 and/or the remote systems 240 specifying a lower charge threshold (e.g., 75%) if the vehicle 10 is located at a higher elevation (e.g., at a top of a hill). Meanwhile, a user-set value for the battery charge threshold received from a user interface device (e.g., the operator interface 48, the user portal 230) may be set at a higher charge threshold (e.g., 85%). In some embodiments, the parameter rule may cause the vehicle controller 100 and/or the remote systems 240 to select the lowest value to ensure that the maximum charge threshold meets the requirements of each of the commanding devices. In some other embodiments, the parameter rule may instead be configured to prioritize the user-set value over the context-based value.

In some embodiments, one or more devices may provide context-based parameter commands associated with a maximum drive power to be provided by the motor (e.g., the prime mover 52) onto the driveline 50 to propel the vehicle 10. For example, one or more external devices or systems may be configured to send commands intended to limit the maximum drive power based on a remaining charge (e.g., sensed by a corresponding sensor 90) left in the battery system (e.g., the energy storage 54). In some embodiments, the one or more external devices or systems can determine how much charge is remaining in the battery system, how much distance the vehicle 10 has yet to travel (e.g., based on GPS information collected by the remote systems 240) to complete a predetermined route (e.g., a golf course), and a maximum charge threshold that will allow for the vehicle 10 to return to a charging station (e.g., at a clubhouse of a golf course). Accordingly, the one or more devices can provide the context-based parameter commands and indicate that they are active, such that the vehicle controller 100 and/or the remote systems 240 consider those values when setting the maximum drive power based on the corresponding parameter rule.

In some embodiments, one or more devices may provide context-based parameter commands associated with a maximum speed of the vehicle 10 or a maximum acceleration or current to be applied by the motor (e.g., the prime mover 52) onto the driveline 50 to propel the vehicle 10. For example, one or more devices or systems may be configured to send commands intended to limit the maximum acceleration or current based on a battery state of health (e.g., sensed by a corresponding sensor 90) of the battery system (e.g., the energy storage 54). For example, if the battery state of health is below a battery health threshold, the maximum acceleration or current to be applied by the motor can be lowered. In some embodiments, one or more devices or systems may be configured to send commands intended to limit the maximum acceleration or current based on an overall system health score determined using sensor data sensed by one or more sensors 90 of the vehicle 10 relating to a health (e.g., a current condition) of the suspension, the brakes, the frame, etc. For example, if the overall system health score is below a system health score threshold, the maximum acceleration or current to be applied by the motor can be lowered. In some embodiments, one or more devices or systems may be configured to send commands intended to limit the maximum speed based on an inferred payload of the vehicle 10. For example, if the inferred payload is above a maximum payload, the maximum speed of the vehicle 10 may be reduced.

In some embodiments, one or more devices can provide multiple parameter commands to the vehicle controller 100 and/or the remote systems 240. For example, in some instances, if a geofence is set up for a particular region (e.g., on a golf course), that geofence can be associated with both a maximum speed and a minimum speed. Accordingly, upon the vehicle 10 entering the geofence, a system (e.g., one of the remote systems 240) may send a command to the vehicle 10 indicating that both a maximum speed value (e.g., 12 mph) is active and that a minimum speed value is active (e.g., 6 mph). As such, if a user-set value for the maximum speed is set above the maximum speed associated with the geofenced region, the maximum speed will be limited to the maximum speed value set for the geofenced region. Alternatively, if the user-set value for the maximum speed is set below the maximum speed value and above the minimum speed value associated with the geofenced region, the maximum speed will be limited to the user-set maximum speed value. However, if the user-set maximum speed value is set below the minimum speed value associated with the geofenced region, the parameter rule may cause the vehicle controller 100 and/or one of the remote systems 240 to disable the vehicle 10 or to exit the geofenced area, since meeting the requirements of each of the commanding devices is not possible within the geofenced area.

It should be appreciated that various devices may send context-based commands based on any of a variety of contextual information pertaining to the vehicle 10. In some instances, the context-based commands may be based on several different factors, such as operational information pertaining to the vehicle (e.g., received via sensors 90), temporal factors (e.g., which day of the week it is), location-based factors (e.g., a GPS location of the vehicle 10), external factors (e.g., current weather conditions, ambient temperature sensed via a sensor 90 on the vehicle 10), etc. In some instances, the context-based commands can be sent based on a weighting of any of these factors and/or a weighting of historical data associated with any of these factors.

It should further be appreciated that, while the description of the method 400 above is provided largely in the context of an electric vehicle, the method 400 for arbitrating between various conflicting vehicle parameter commands from multiple devices can be similarly applied to any vehicle configured to receive vehicle parameter commands from multiple devices. For example, the method 400 can similarly be applied to a vehicle powered via an internal combustion engine, a fuel cell, a hybrid power source, or any other vehicle power type.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle controller 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A vehicle system comprising:
at least one processing circuit having at least one processor and at least one memory, the at least one memory storing instructions thereon that, when executed by the at least one processor, cause the at least one processor to:
receive a parameter rule associated with a vehicle parameter;
receive a persistent value for the vehicle parameter;
determine that a user-set value for the vehicle parameter is active;
determine that a context-based value for the vehicle parameter is active; and
set the vehicle parameter to one of the persistent value, the user-set value, or the context-based value based on the parameter rule.

2. The vehicle system of claim 1, wherein the vehicle parameter includes at least one of a maximum speed, a maximum acceleration rate, a maximum current applied by a motor of the vehicle, a maximum battery charge threshold for the motor, or a maximum drive power level.

3. The vehicle system of claim 2, wherein setting the vehicle parameter based on the parameter rule includes:
comparing the persistent value, the user-set value, and the context-based value; and
setting the vehicle parameter to a lowest of the persistent value, the user-set value, and the context-based value.

4. The vehicle system of claim 1, wherein the vehicle parameter includes at least one of a stability control level or an anti-skid control level.

5. The vehicle system of claim 1, wherein the instructions further cause the at least one processor to:
receive user-set parameter command information from a user interface device via a communications network, the user-set parameter command information including a user-set activity status and the user-set value;
receive context-based parameter command information from a context analysis device or system via the communications network, the context-based parameter command information including a context-based activity status and the context-based value;
wherein determining that the user-set value is active is based on the user-set activity status being set to active; and
wherein determining that the context-based value is active is based on the context-based activity status being set to active.

6. The vehicle system of claim 5, wherein the context-based value is a geofence-based value, and the context-based activity status is set to active based on a determination by the context analysis device or system that a vehicle is entering or is within a geofence associated with the context-based value.

7. The vehicle system of claim 6, wherein the context-based activity status is set to active based on a determination that the vehicle is entering or has entered the geofence, wherein the vehicle is set to the user-set value based on the parameter rule, and wherein the instructions further cause the at least one processor to:
determine that the user-set value is below a minimum value associated with the geofence; and
cause the vehicle to exit the geofence, instruct an operator off the vehicle to exit the geofence, or disable the vehicle.

8. The vehicle system of claim 5, wherein the context-based value is a weather-based value, and wherein the weather-based value is set to active based on a notification of inclement weather received by the context analysis device or system.

9. The vehicle system of claim 8, wherein the parameter rule specifies that, when the weather-based value is active, the vehicle parameter is set to the weather-based value.

10. The vehicle system of claim 5, wherein the context-based value is changed between different values by the context analysis device or system based on a time, week, or event schedule for a location at which the vehicle is present.

11. The vehicle system of claim 1, further comprising one or more sensors configured to sense one or more operational parameters of the vehicle, and wherein determining that the context-based value is active is based on the one or more operational parameters of the vehicle.

12. The vehicle system of claim 11, wherein the one or more operational parameters include one or more of a vehicle orientation grade angle of the vehicle, a vehicle turning angle of the vehicle, a system health score of the vehicle, a motor torque of a motor of the vehicle, or an inferred payload of the vehicle.

13. The vehicle system of claim 11, further comprising a battery system, and wherein the one or more operational parameters comprise at least one of a charge level of the battery system or a battery state of health of the battery system.

14. The vehicle system of claim 1, further comprising a vehicle, wherein the at least one processing circuit is at least one of local to or remote from the vehicle.

15. The vehicle system of claim 14, wherein the vehicle is a golf cart.

16. A vehicle control system comprising:
at least one processing circuit having at least one processor and at least one memory, the at least one memory storing instructions thereon that, when executed by the at least one processor, cause the at least one processor to:
receive a parameter rule associated with a vehicle parameter;
receive a persistent value for the vehicle parameter;
determine that one or more of a user-set value for the vehicle parameter is active or a context-based value for the vehicle parameter is active; and
set the vehicle parameter to one of the persistent value, the user-set value, or the context-based value based on the parameter rule and the determination that the one or more of the user-set value or the context-based value is active.

17. The vehicle control system of claim 16, wherein the instructions further cause the at least one processor to:
receive one or more of user-set parameter command information from a user interface device or context-based parameter command information from a context analysis device or system, the one or more of the user-set parameter command information or the context-based parameter command information including an activity status,
wherein determining that the one or more of the user-set value is active or the context-based value is active is based on the activity status.

18. A method comprising:
receiving, by at least one processing circuit, a persistent value for a vehicle parameter;
determining, by the at least one processing circuit, that a user-set value for the vehicle parameter is active based on user-set parameter command information received from a user interface device;
determining, by the at least one processing circuit, that a context-based value for the vehicle parameter is active based on context-based parameter command information received from a context analysis device or system; and
setting, by the at least one processing circuit, the vehicle parameter to one of the persistent value, the user-set value, or the context-based value based on a parameter rule.

19. The method of claim 18, wherein the vehicle parameter is a maximum speed of a vehicle, and wherein setting the maximum speed based on the parameter rule includes:
comparing the persistent value, the user-set value, and the context-based value; and
setting the maximum speed to a lowest of the persistent value, the user-set value, and the context-based value.

20. The method of claim 19, wherein determining that the context-based value is active is performed based on a determination by the context analysis device or system that the vehicle is entering a geofence associated with the context-based value, wherein the vehicle is set to the user-set value, and wherein the method further comprises:
determining, by the at least one processing circuit, that the user-set value is below a minimum speed associated with the geofence; and
causing the vehicle to exit the geofence, instructing an operator off the vehicle to exit the geofence, or disabling the vehicle.
